(19) United States
(12) Patent Application Publication
(10) Pub. No.: US 2006/0189742 A1
(43) Pub. Date: Aug. 24, 2006

(54) Elastomer modifed olyamides for improving the breaking resistance of films and hollow elements

(76) Inventors: Ralf Ulrich, Ratingen (DE); Matthias Mahlke, Dormagen (DE); Marcus Schafer, Krefeld (DE); Helmut Schulte, Krefeld (DE); Peter Schwarz, Krefeld (DE); Martin Hoch, Heinsberg (DE); Roland Parg, Leverkusen (DE)

Correspondence Address: Lanxess Corporation;Law & Intellectual Property Department, 111 Ridc Park West Drive, Pittsburgh, PA, 15275-1112, US

(21) Appl. No.: 10/525,160

(22) PCT Filed: Aug. 13, 2003
(86) PCT No.: PCT/EP03/08978

§ 371 Date: Sep. 26, 2005

(30) Foreign Application Priority Data
Aug. 19, 2002 (DE) 102 37 820.7
Jul. 1, 2003 (DE) 103 29 451.1

(51) Int. Cl. C08K 3/34

(52) U.S. Cl. 524/442

(57) ABSTRACT

The invention relates to molded flexible polyamide materials containing polyamide and olefin/vinyl acetate copolymers, films and hollow elements comprising at least one layer of said molded materials, and methods for producing the molded materials, films, and hollow elements.

The present invention relates to flexible polyamide molding compositions comprising polyamide and copolymers composed of olefins and vinyl acetate, and also to films or hollow bodies comprising at least one layer composed of these molding compositions, and to processes for preparation of the molding compositions and production of the films and hollow articles.

Polyamides feature a wide variety of advantageous properties, e.g. high toughness, high thermal stability, etc., and these ensure that they have a secure position in the market in the engineering thermoplastics sector. These fundamental properties of the polymer are generally modified via addition of additives. Polymers and additives together give what is known as the molding composition. Polyamide molding compositions are used in many applications. By way of example, mention may be made of injection moldings, e.g. for the automobile market, or extrudates, such as films or hollow articles for the packaging sector.

The literature (e.g. H.-G. Elias, “An introduction to polymer science”, VCH Verlagsgesellschaft mbH. Weinheim, 1997) disclose that the morphology and mechanical properties of thermoplastics are influenced via addition of elastomers. By way of example, impact strength, in particular dry impact strength, and tensile strain at break are increased, while modulus of elasticity and ball-impression hardness are reduced.

The combination of polyamides with elastomer e.g. for improvement of the abovementioned properties, is described in patents. Elastic polymers, such as polyolefins but also elastomers based on rubbers, such as polybutadiene-acrylonitrile or modified graft polymers, are often admixed. By way of example, the combination of polyamides and elastomeric polypropylenes is known from EP-B 0 640 650 B1 and DE-C 4131908. EP-A 34 704 discloses mixtures composed of nylon-6,6, nylon-6, and EPDM. The use of impact modifiers is also described by way of example in EP-13 0 583 706 and U.S. Pat. No. 4,410,661. A frequent disadvantage of blends, of this type is inadequate heat resistance.

Some applications of elastomer-modified polymers have also been described in the sector of films and hollow articles. DE-A 19 621 688 describes the production of transparent, non-blocking films based on polystyrene which are modified via addition of styrene-butadiene block copolymers and of ethylene-vinyl acetate copolymers having 8% vinyl acetate content, and also of three other additives. DE-A 19 535 400 discloses thermoplastic molding compositions based on polystyrene which are modified via addition of polyamide, of ethylene-butylene-styrene block copolymers, and of four other components. A disadvantage of the patents is the large number of components needed for the desired modification. Furthermore, the molding compositions comprise elastomers with unsaturated units which can, for example, lead to cleavage of the elastomer via enzymatic degradation or by an ozonolytic route.

EP-A 0 382 048 discloses thermoplastic molding compositions composed of semicrystalline nylon-6,6 or of semicrystalline semiaromatic copolyamides which, inter alia, also comprise a rubber composed of monomers of the group of the α-olefins, primary or secondary alkyl esters of acrylic acid or methacrylic acid, ethylenically unsaturated mono- or dicarboxylic acids, or epoxide-containing monomers, or composed of a rubber without acid-functional groups. However, the constitution described for the thermoplastic molding compositions permits primarily applications in the large-surface-area moldings sector, examples being wheel caps or exterior parts of motor vehicles. High strength and stiffness are disadvantages for applications in the film sector. Similar factors also apply to EP 0 532 963.

The patent applications WO-A 00/23507, WO-A 00/23508, and WO-A 00/23515 describe the increase in the buckling endurance of films which comprise nanoscale fillers. Semiaromatic copolyamides with particles of size below 100 nm are cooled at a rate of from 10 to 20° C. per minute from the fully molten state, whereupon crystalline structures are produced, starting from the surface of the particles. These materials have increased barrier properties. The increase in buckling endurance is achieved via a modification of the process parameters. However, a substantial disadvantage is that the parameters defined above have to be maintained during the process.

The patent JP-A 2000168010 discloses polyamide composites which comprise copolymers composed of aliphatic polyamides, polyoxyalkylene glycol, and also polybutadiene for improvement of puncture resistance. A disadvantage is that various additives have to be used, and this can adversely effect transparency. WO 93/00404 A1 describes the production of flexible films based on polyamide via addition of from 5 to 50% of a polyolefin modified via functional groups. A disadvantage is the high content of olefin which can lead to increased haze.

DE-C 3941529, JP-A 51028138, and JP-A 60161452 disclosed polyamide compositions, each of which comprises a hydrolyzed ethylene-vinyl acetate copolymer (degrees of hydrolysis >90%). The hydrolysis of ethylene-vinyl acetate represents an additional step in the process, and moreover compatibility between the hydrolyzed copolymer and the resin is not necessarily satisfactory.

EP-A 0225164 says that the buckling endurance of multilayer films can be improved by embedding the polyamide layer between layers composed of, by way of example, copolymers composed of ethylene and carboxylic acids. A disadvantage with this method is that 3 layers are needed to increase buckling endurance.

Films and hollow articles which comprise a polyamide layer feature a wide variety of advantageous properties. Mention should particularly be made of good optical properties, such as high transparency of films or hollow articles with high surface gloss. Other important factors are good mechanical properties, such as high toughness, high puncture resistance, high tear-propagation resistance, and other properties. Simplicity of production and simplicity of further processing are additional factors here.

A particularly important factor for many application sectors for films and hollow articles, in particular for use in the packaging sector, e.g. for foods or cosmetics, is low permeability for oxygen, water vapor, carbon dioxide, fats, flavors, and other substantial components of the packed product, or for substances which are to be kept away from the packed product, and also high flexibility of the film.

The object of the invention was an increase in the buckling endurance of films or, respectively, hollow articles, comprising at least one layer composed of molding compositions based on polyamide, while permitting continued use of the production processes commonly used.

Surprisingly, it has now been shown that modification of polyamides with elastomers, namely with copolymers composed of olefins and vinyl acetate, achieves the object and, by way of example, can achieve the properties demanded above in relation to high flexibility of the film. In one preferred variant of the invention, the elastomer used comprises ethylene-vinyl acetate polymer. In one particularly preferred variant of the invention, the elastomer used comprises ethylene-vinyl acetate polymer with high contents of vinyl acetate. The polyamide resin may be modified using a masterbatch, or via a pellet mixture of the individual components.

The invention provides compositions comprising
A) from 99.9 to 50% by weight of polyamide and
B) from 0.1 to 50% by weight of copolymers composed of olefins and vinyl acetate.

The invention likewise provides the use of these polyamide molding compositions for production of films or of hollow articles.

This invention also provides processes for preparation of the inventive molding compositions via melt compounding of the components and for production of the corresponding films and hollow articles comprising at least one layer of the inventive molding composition.

The invention further preferably provides singe or multilayer films or hollow articles comprising at least one layer of the inventive molding composition.

The invention further preferably provides mono- or biaxially stretched single- or multilayer films or hollow articles comprising at least one layer of the inventive molding composition.

The invention also provides packaging composed of an inventive film or of an inventive hollow article.

Preference, particular preference, or very particular preference is given to embodiments which use the parameters, compounds, definitions, and explanations mentioned below as preferred, particularly preferred, or very particularly preferred.

However, the abovementioned general definitions, parameters, compounds, and explanations, and those mentioned in preferred ranges, can also be combined with one another, i.e. between the respective ranges and preferred ranges, as desired.

The polyamide which is present in the polyamide layer of the inventive molding compositions, films, or hollow articles is a known aliphatic or aromatic or semiaromatic homopolyamide or copolyamide, or a mixture of two or more polyamides. Examples of materials preferably used are, independently of one another, nylon-6, nylon-6,6, nylon-10, nylon-11, nylon-12, nylon-4,6, nylon-6, 10, nylon-6,I, nylon-6,12, nylon-6/6,6, nylon-6,1/6,T, nylon-MXD6, nylon-6/6I, nylon-6/6,T, nylon-6/IPDI, and copolymers, and also polymer mixtures from these groups.

Particular preference is given to use of nylon-6 or nylon-6,6, or of a copolyamide composed of caprolactam units and units derived from hexamethylendiamine and isophthalic acid or hexamethylenediamine and terephthalic acid, or hexamethylenediamine and adipic acid.

The inventive modification of polyamides takes place via elastomers having polar groups, preferably using olefin-vinyl acetate copolymers or ethylene-acrylate copolymers. The average molar mass (number-average, determined by means of GPC) of the olefin-vinyl acetate copolymers is in the range from 30 to 500 kg/mol, and they have MFI values of from 0.5 to 100. These copolymers advantageously have a vinyl acetate content of from 30 to 99% by weight, preferably from 40 to 95% by weight, and most preferably from 80 to 90% by weight.

The selection of the MFI value or molecular weight of olefin-vinyl acetate copolymers to be used according to the invention depends on the parameters for processing of the polyamide. The material may be incorporated into the inventive polyamide in an extruder which has sufficient mixing zones. A masterbatch or a mixture of pellets of the individual components of the inventive components may be mixed in an extruder and directly processed to give corresponding molding compositions, an alternative being first to prepare a concentrate in a mixer. The conditions for preparation of die inventive mixture depend mainly on the melting behavior of the polyamide and its viscosity, and are therefore easily determined by the person skilled in the art. By way of example, the melt temperatures are from 250 to 330° C., preferably from 265 to 300° C., and the residence time may be from 0.5 to 5 minutes, preferably from 05 to 2 minutes.

Examples of preferred olefin-vinyl acetate copolymers are Levamelt 400, Levamelt 450, Levamelt 500, Levamelt 600 HV, Levamelt 700, Levamelt 800, and Levapren 8939, these being obtainable from Bayer AG. The respective vinyl acetate contents of these polymers are 40±1.5% by weight, 50±1.5% by weight, 60±1.5% by weight, 70±1.5% by weight, 80±2.0% by weight, and 92±2.0% by weight.

These olefin-vinyl acetate copolymers may also be used in the form of a mixture composed of two or more different materials from the olefin-vinyl acetate copolymers mentioned.

The olefin-vinyl acetate copolymers are prepared using the copolymerization processes customary in industry, e.g. via high-pressure copolymerization with the aid of initiators which decompose to give free radicals. This copolymerization may take place in the gas phase, in solution, or in suspension, either continuously or else batchwise. However, preference is given to solution polymerization because this method is particularly suitable for producing gel-free products for film extrusion.

These preparation processes are known to the person skilled in the art and working in rubber technology and are described by way of example in V. E. Rohde, 141st Meeting at the ACS, Louisville 1992, and also in EP-A 0 341 499, DE-A 3 825 450, and EP-A 0510 478.

The olefin-vinyl acetate copolymers are preferably used in pure form, but may also be used in blends with other polar olefin copolymers, for example olefin-vinyl alcohol copolymers, olefin-maleic anhydride copolymers, olefin-acrylate copolymers. These additions may make up from 0.1 to 50% by weight of the inventive molding compositions. The elastomers preferably make up from 0.1 to 10% by weight, particularly preferably from 0.1 to 5% by weight, of the inventive molding compositions.

The inventive films or hollow articles may be composed merely of one polyamide layer or may have a multilayer structure. In the case of the multilayer structure, the other layers may be composed, by way of example, of polyolefins, e.g. polyethylene, or of polyethylene copolymers, e.g. copolymers composed of ethylene and acrylic acid or methacrylic acid, or of barrier polymers, e.g. polyvinylidene chloride, or of copolymers composed of ethylene and vinyl alcohol.

The molding compositions may moreover preferably comprise nanoscale fillers.

The use of nanoscale systems for increasing the level of barrier properties is described in the literature. EP-A 0 358 415 describes films composed of polyamides which comprise phyllosilicates and thus exhibit a higher oxygen barrier. The slip properties and the transparency of single-layer amorphously quenched films is unchanged in comparison with pure nylon-6. A disadvantage of these films is the increase in stiffness and, associated therewith, the reduction in buckling endurance.

The patent applications WO-A 93/04117, WO-A 93/04118, and WO-A 93/11190 describe polymers comprising nanocomposites with lamellar particles in the thickness region of a few nanometers. In particular, composites composed of nylon-6 and montmorillonite or nylon-6 and silicates are mentioned. An advantage in this case is parallel orientation of the particles with respect to the film surface. Applications as monofilm and multilayer film are described, and the finished films here may optionally be stretched in order to achieve better orientation of the nanoparticles. Advantages of these films are in turn the increased level of barrier properties, high strength in the moist state, and lower water absorption. The substantial disadvantages of these films are high stiffness and the resultant low buckling endurance and low picture resistance.

EP-A 0 810 259 describes polyamide molding compositions which comprise nanoscale fillers from the group of the oxides and oxide hydrates of metals and of semimetals, and also films and hollow articles which comprise at least one corresponding polyamide layer. These films have lower oxygen permeation while haze is almost unchanged. A disadvantage is again high stiffness and lower buckling endurance, and also lower gloss.

Nanoscale fillers are particles whose linear dimension in a selectable direction is less than 1 micrometer. Examples of methods for determining the average particle size are visual assessment of transmission electron micrographs of ultrathin sections of the corresponding molding compositions. If the particles are highly anisotropic, the particle size means the size of the smallest axis present. For example, in the case of lamellar particles the particle size means the lamellar thickness. An example of an overview of nanoscale fillers is found in Nanocomposites—auf dem Weg zur Anwendung [Nanocomposites—pathways toward application], KU Kunstgtoffe, 10, 91, 2001, 178-190.

The nanoscale fillers used according to the invention can be those selected from the group of the oxides, oxide hydrates of metals or of semimetals. According to the invention, preference is given to oxides or oxide hydrates of an element of the group boron, aluminum, gallium, indium, silicon, tin, titanium, zirconium, zinc, yttrium, or iron.

Dendritic or highly branched compounds may also be used. By way of example, these may have been selected from the group of the polyethyleneimines, polypropyleneimines, polyesteramides, polyesters, or polyethers.

Preference is given to use of nanoscale fillers from the group of the phyllosilicates. These can derive from the group of the phyllosilicates such as magnesium silicate or aluminum silicate, and also montmorillonite, saponite, beidellite, nontronite, hectorite, stevensite, vermiculite, halloysite, or their synthetic analogues, and may have been organically modified.

The nanoscale fillers may be added to the reaction mixture at an early stage: at the start of the polymerization. However, it is also possible to use nanoscale fillers to modify the existing polymer in a second step of the process. The amount of nanoscale fillers incorporated into the polymer may be from 0.1 to 10% by weight, preferably form 0.1 to 5.0% by weight

The inventive fillers may be added prior to, during, or after the polymerization process. It is also possible to add the various fillers separately. The nanoscale particles are preferably added during the polymerization process. The inventive elastomers are preferably added in the form of a dry blend or masterbatch.

When the inventive fillers are added, they may already take the form of particles with the particle size finally occurring in the molding composition. As an alliterative, the inventive fillers may be added in the form of precursors from which the particles finally occurring in the molding composition are not produced until the addition or incorporation process has begun.

The inventive molding compositions, films, or hollow articles are produced in a known manner, e.g. via extrusion, coextrusion, coating, lamination, or blow molding. Examples of extrusion or coextrusion methods used in the case of the films are what is known as the chill-roll process or the blow-extrusion process or the blow-coextrusion process. In the case of multilayer films or hollow articles, use may be made of the commercially available adhesion promoters.

The starting polyamides for the inventive polyamide molding compositions may be prepared in a continuous process or a batch process, in a known manner. An example of a batch process is polymerization in an autoclave. An example of a continuous process is polymerization in what is known as a precondensation pipe. Preparation by a continuous process is preferred. To achieve the high molecular weights often required for the film material application, solid-phase post-condensation may be carried out downstream of the polymerization to give the melt. The inventive elastomers are preferably added in the form of a dry blend or masterbatch.

The inventive molding compositions, films, or hollow articles may be subjected to fiercer mechanical operations or forming prior to their final intended use. For example, the inventive films may be thermoformed. The inventive films or hollow articles may, by way of example, be used for packaging purposes. Inventive films or hollow articles may, by way of example, be used for the packaging of foods, such as meat and meat products, sausage, cheese, drinks, etc. The inventive films or hollow articles may, by way of example, also be used for packaging of cosmetics, e.g. sun-protection creams, or of chemicals, e.g. plant-protection compositions. The inventive hollow articles may moreover serve as lines or tanks. By way of example, those may be lines or tanks for fuels or oils for automobiles.

The marked improvement found here in buckling endurance by virtue of admixture of the inventive elastomer was particularly surprising because the only polyamide modifiers hitherto recommended in the prior art have been acid-grafted ethylene-propylene copolymers. Surprisingly, the action is apparent with admixtures of as little as 1% by weight, while capability to give entirely satisfactory extrusion of very thin films is surprisingly retained.

### EXAMPLES

Test Methods:

Buckling endurance is determined by the Gelboflex test (MIL-B-131D). Temperature and relative humidity are at normal room levels. The dimensions of the specimen are l=29.6 cm, w=22.0 cm, p=about 60 μm. The cylinder is rotated by 360 degrees with a cycle length of 10.5 cm and a cycle frequency of 35/min.

MFI was measured to DIN 53735 under conditions of 190° C. and 2.16 kg.

GPC was carried out under standard conditions on a Shodex RI-71 column and with THF as solvent at 45° C. 100 μl of a 0.05% solution of the polymer was injected Polystyrene standards were used for calibration. The results were validated via commercially available polyvinyl acetate standards.

Materials Used

Durethan®1 B 38 FKA, commercially available polyamide from Bayer AG

Levamelt™ 400, ethylene-vinyl acetate copolymer with 40% by weight vinyl acetate and with an MFI value of 1.5, from Bayer AG

Levamelt™ 800 HV, ethylene-vinyl acetate copolymer with 80% by weight vinyl acetate and with an MFI value of 4, from Bayer AG

### Comparative Example 1

40 kg of a commercially available polyamide (Durethan® B38 FKA) are processed in an extruder with flat-film die at a melt pressure of 122 bar, a melt temperature of 255° C., and a rotation rate of 79 rpm. The chill-roll is at 60° C. and the cooling roll is operated at 40° C. The plant speed is 46 m/min.

### Inventive Example 1

36 kg of a commercially available polyamide (Durethan® B38 FKA) and 4 kg of a polyamide masterbatch (Durethan® B38 FKA) comprising 5% of Levamelt 400 with a proportion of 40% of vinyl acetate are processed as in comparative example 1.

### Inventive Example 2

36 kg of a commercially available polyamide (Durethan® B38 FKA) and 4 kg of a polyamide masterbatch (Durethan® B38 FKA) comprising 2% of Levamelt 400 with a proportion of 40% of vinyl acetate are processed as in comparative example 1.

### Inventive Example 3

36 kg of a commercially available polyamide (Durethan® B38 FKA) and 4 kg of a polyamide masterbatch (Durethan® B38 FKA) comprising 2% of Levamelt 400 with a proportion of 40% of vinyl acetate are processed as in comparative example 1.

### Inventive Example 4

36 kg of a commercially available polyamide (Durethan® B38 FKA) and 4 kg of a polyamide masterbatch (Durethan® B38 FKA) comprising 0.5% of Levamelt 400 with a proportion of 40% of vinyl acetate are processed as in comparative example 1.

### Inventive Example 5

36 kg of a commercially available polyamide (Durethan® B38 FKA) and 4 kg of a polyamide masterbatch (Durethan® B38 FKA) comprising 5% of Levamelt 800 with a proportion of 80% of vinyl acetate are processed as in comparative example 1.

### Inventive Example 6

36 kg of a commercially available polyamide (Durethan® B38 FKA) and 4 kg of a polyamide masterbatch (Durethan® B38 FKA) comprising 2% of Levamelt 800 with a proportion of 80% of vinyl acetate are processed as in comparative example 1.

### Inventive Example 7

36 kg of a commercially available polyamide (Durethan® B38 FKA) and 4 kg of a polyamide masterbatch (Durethan® B38 FKA) comprising 1% of Levamelt 800 with a proportion of 80% of vinyl acetate are processed as in comparative example 1.

### Inventive Example 8

36 kg of a commercially available polyamide (Durethan® B38 FKA) and 4 kg of a polyamide masterbatch (Durethan® B38 FKA) comprising 0.5% of Levamelt 800 with a proportion of 80% of vinyl acetate are processed as in comparative example 1.

The products from comparative example 1 and from inventive examples 1 to 2 were studied for buckling endurance and hane. The results are given in table 1.

TABLE 1
Buckling endurance (film thickness about 60 μm)

| | Buckling endurance [200 cycles] |
|---|---|
| | (total of 3 measurements) |
| Comparative example | 10/4/2//16 |
| Inventive example 1 | 0/1/2//3 |
| Inventive example 2 | 2/2/0//4 |
| Inventive example 3 | 1/3/3//7 |
| Inventive example 4 | 6/3/2//11 |
| Inventive example 5 | 1/1/0//2 |
| Inventive example 6 | 2/3/2//7 |
| Inventive example 7 | 8/2/0//10 |
| Inventive example 8 | 6/2/1//9 |

Key: a/b/c//d
a: holes >8 mm
b: holes from 4-8 mm
c: holes from 1-3 mm
d: total

Table 1 shows that addition of very small amounts of Levamelt can improve buckling endurance. In particular, there was a marked reduction in the number of large holes >8 mm.

What is claimed is

1. A composition comprising
A) from 99.9 to 5% by weight of polyamide and
B) from 0.1 to 50% by weight of copolymers comprising olefins and vinyl acetate.

2. The composition as claimed in claim 1, where
B) is polyalkylene-vinyl acetate.

3. The composition as claimed in one or more of the preceding claims, where B is ethylene-vinyl acetate polymer.

4. The composition as claimed in one or more of the preceding claims, where the proportion by weight of vinyl acetate, based on component B, is from 30 to 99% by weight.

5. The composition as claimed in claim 4, where the proportion by weight is from 40 to 95% by weight.

6. The composition as claimed in claim 4, where the proportion by weight is from 80 to 90% by weight.

7. The composition as claimed in one or more of the preceding claims, where at least one nanoscale filler is present.

8. The composition as claimed in claim 7, where the nanoscale filler is a phyllosilicates.

9. The composition as claimed in claim 7 or 8, where the nanoscale filler has been selected from the group of the oxides and oxide hydrates of metals or of semimetals.

10. The composition as claimed in any of claims 7 to 9, where the nanoscale filler is used in the range from 0.1 to 5% by weight, based on the polyamide.

11. A process for preparation of a composition as claimed in claim 1 via melt compounding of the constituents, where nanoscale fillers and elastomers may be metered in either together or else separately from each other.

12. A process for preparation of a composition as claimed in claim 1 via melt compounding of the constituents, where the elastomer is incorporated in the form of a masterbatch or in the form of a pellet mixture.

13. The use of molding compositions as claimed in claim 1 for production of moldings, of single or multilayer films or of hollow articles.

14. A molding, a single- or multilayer film, or a hollow article produced from molding compositions as claimed in claim 1.

15. The use of hollow articles as claimed in claim 14 as line and/or tanks.

16. The use of copolymers composed of olefins and vinyl acetate for improvement of the buckling endurance of thermoplastics.
